(19) United States
(12) Patent Application Publication
(10) Pub. No.: US 2003/0090851 A1
(43) Pub. Date: May 15, 2003

(54) Device for electrostatic charging of a multilayer paper web

(75) Inventor: Werner Blim, Frankenthal (DE)

Correspondence Address: Jones, Tullar & Cooper, P.C., Eads Station, P.O. Box 2266, Arlington, VA, 22202, US

(73) Assignee: Koenig & Bauer Aktiengesellschaft

(21) Appl. No.: 10/323,878

(22) Filed: Dec. 20, 2002

Related U.S. Application Data
(63) Continuation of application No. 09/403,001, filed on Oct. 15, 1999.
Application No. 09/403,001 is a 371 of international application No. PCT/DE98/01063, filed on Apr. 16, 1998.

(30) Foreign Application Priority Data
Apr. 18, 1997 (DE) 197 16 325.4

(51) Int. Cl. H02B 1/00

(52) U.S. Cl. 361/225

(57) ABSTRACT

A multiple layer paper web is provided with an electrostatic charge for the purpose of adhering the multiple webs to each other. A pair of oppositely charged rollers contact the surface of the multiple layer printing aper web and impart the charge to the web. The pair of oppositely charged rollers are positioned directly before a cylinder folding group of a web-fed rotary printing press.

The invention relates to a device in accordance with the preambles of claims 1, 19, 20, 21 and 22 for electrostatically charging a multilayer ribbon.

It is generally known and described in EP 0 230 305 A2 that in rotogravure printing the incoming material webs, or respectively ribbons, adhere electrostatically, which is called ribbon adherence. The stability of the material webs is increased by means of this electrostatic interlocking, so that the danger of a formation of corners of the printed products in the folding apparatus is reduced. Electrodes, which are arranged at both sides of the material webs and at a distance from the material webs are provided for applying the electrostatic charge.

In connection with this electrostatic charge its low effectiveness on the ribbon is disadvantageous, so that it became necessary to arrange additional devices, for example electrostatically charged guide devices, as disclosed in EP 0 230 305 A2 in order to reduce the effects of the so-called whip action, which leads to the formation of corners.

DE 31 17 419 C2 describes a method for the electrostatic charging of a multilayer ribbon. Here, the ribbon is charged by means of contactless acting electrodes after the webs have been brought together to form a ribbon downstream of a pair of compression rollers.

DE 27 54 179 C2 discloses a method for the electrostatic charging of a multilayer ribbon, wherein the edge areas of each layer are individually charged by means of rollers.

The object of the invention is based on providing a device for the electrostatic charging of a multilayer ribbon.

In accordance with the invention, this object is attained by the characteristics of claims 1, 19, 20, 21 and 22.

The advantages which can be achieved by means of the invention lie in particular in that charging of the ribbon takes place so lastingly, that further devices for preventing, or respectively reducing, the formation of corners can be omitted. For example, an already provided pair of drawing rollers, which is required for the operation of the folding apparatus and has been modified in its design for the purpose of transmitting a voltage, is used as the device for charging the ribbon.

The strength of the voltage required for charging the ribbon is reduced in comparison with the voltage required by the prior art.

An exemplary embodiment of the invention is represented in the drawings and will be described in greater detail in what follows.

Shown are in:

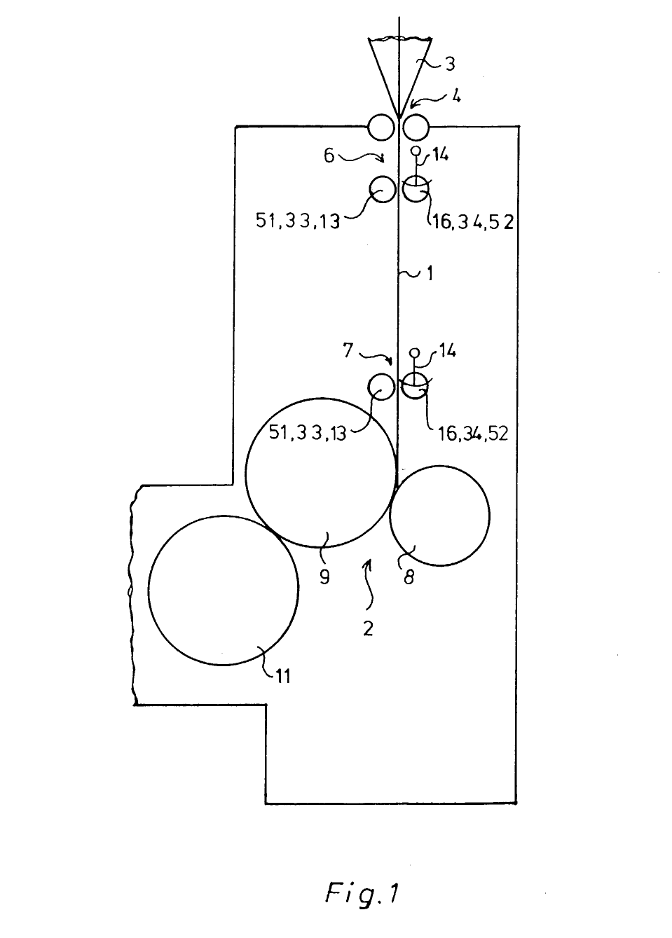

FIG. 1, a schematic representation of a longitudinal folding device, as well as the ribbon entry into a cylinder folding group;

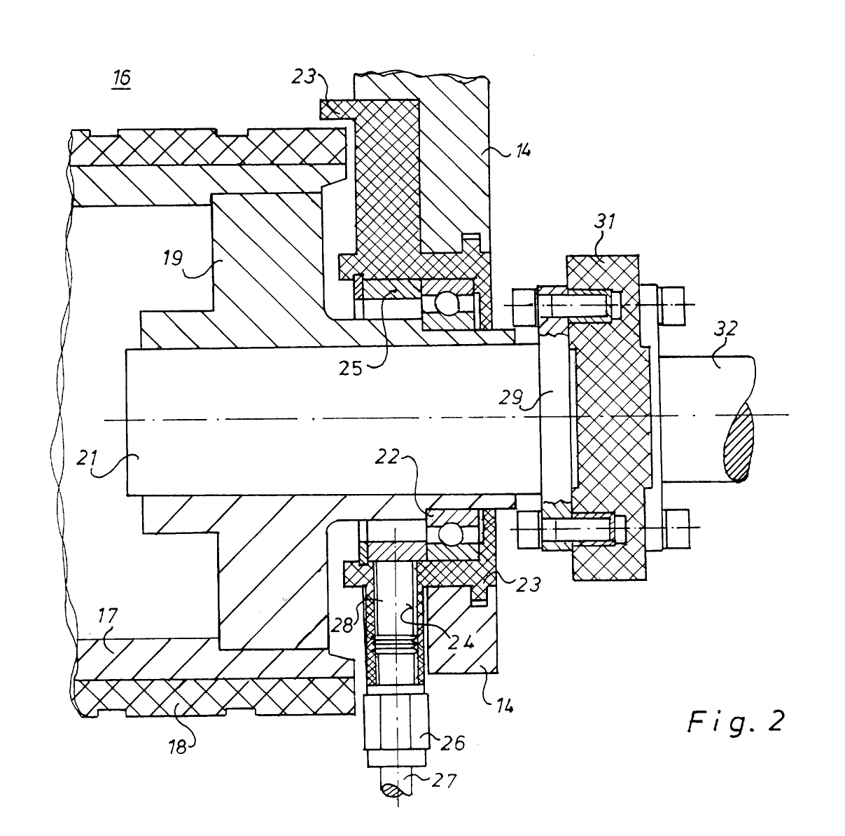

FIG. 2, a longitudinal section through one roller of the invention of a pair of rollers in accordance with FIG. 1;

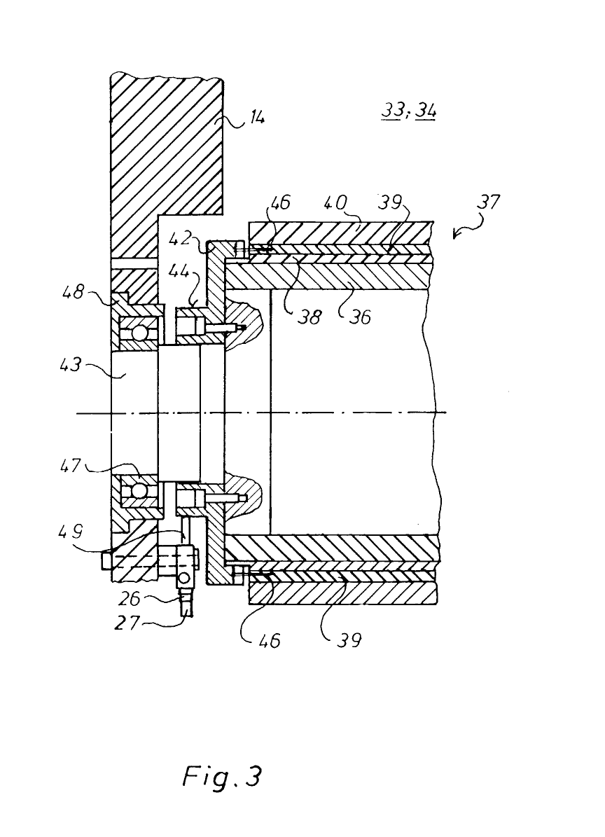

FIG. 3, a representation analogous to FIG. 2, but with a second embodiment variation;

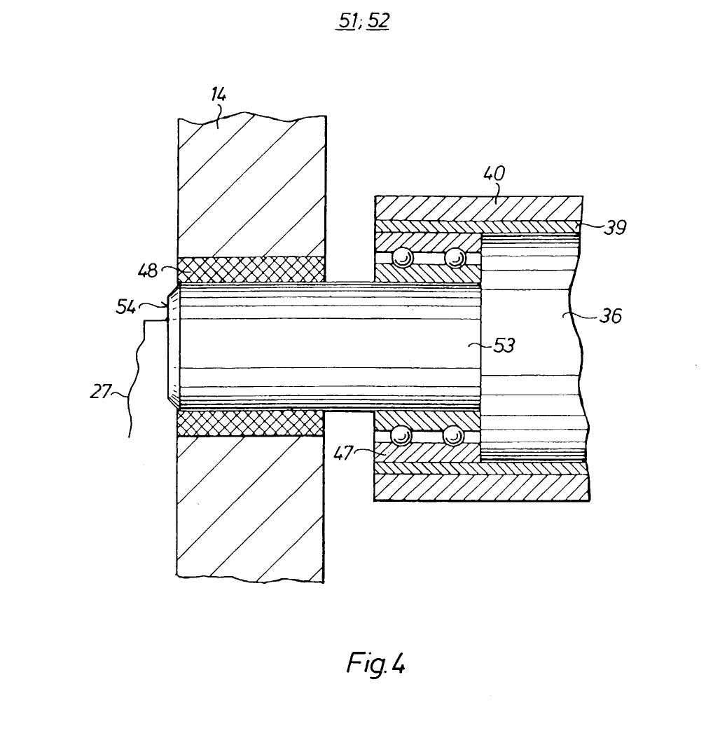

FIG. 4, a representation analogous to FIG. 2, but with a third embodiment variation.

A longitudinal folding device 3 with a pair of funnel folding rollers 4, as well as two pairs of rollers, for example drawing roller pairs 6, 7, are arranged ahead of the entry for a multilayer ribbon 1, for example a plurality of paper webs, into a cylinder folding group 2, for example, of a folding apparatus of a rotary printing press.

The cylinder folding group 2 has a cutter cylinder 8 and a collection cylinder 9, which operates against the cutter cylinder 8 and in turn works together with a folding jaw cylinder 11. The printed products, which have been transversely folded there, are supplied to a further processing station by means of a conveying device, for example a belt conveyor device.

The pair of drawing rollers 7 arranged directly in front of the entry into the cylinder folding group 2 respectively consists of a first roller 13, seated fixed in a lateral frame, and a second roller 16, which is seated on a pivot arm or bearing element 14 and can be placed against the roller 13 seated fixed in the lateral frame, both constituting the charging electrodes. The running ribbon 1 is conducted between the two rollers 13, 16.

In accordance with a first embodiment variation (FIG. 2), both rollers 13, 16 consist of a cylinder- or hollow cylinder-shaped roller body, a metal body 17, which has a shell 18 of a resilient covering of reduced conductivity, for example rubber of a hardness of approximately 85° Shore. The metal body 17 is connected, fixed against relative rotation, at both ends by means of hubs 19—only one end is represented—with the shaft journal 21.

The hubs 19 are fastened, electrically insulated, by means of ball bearings 22 in the bearing element 14. An insulation consists, for example, of respective bushings 23 of insulating material, for example a resin-bonded fabric, arranged between the pivot arm, or respectively the bearing element 14, and the ball bearing 22, which has a radial bore 24 for receiving a cable feed 26. The cable feed 26 receives a feed line, for example a cable 27 which, for the purpose of transferring energy via an intermediate ring 25, is pressed by means of a spring-loaded contact element 28 against the ball bearing 22.

At its end remote from the roller the shaft journal 21 is connected, fixed against relative rotation, with an annular flange 29, which in turn is in connection, fixed against relative rotation, via a piece 31 of insulating material with a driveshaft 32.

Thus, each one of the rollers 13, 16 can be separately driven. Moreover, a first roller 13 of the pair 7 of drawing rollers is connected with a negative pole of a d.c. source, not represented, of approximately 5 kilovolts, for example a high tension d.c. generator, and a second roller 16 of the pair 7 of drawing rollers is connected with a positive pole of the d.c. source. But the polarity can also be reversed.

The ribbon 1 preferably consists of paper webs, which are weakly mineralized and highly resistive.

It is also possible to drive only one roller 13 or 16 of the pair of rollers 13, 16, or none of the rollers of the pair of rollers 13, 16.

In accordance with a second embodiment variation (FIG. 3), both charge electrodes, which are designed as rollers 33, 34, also consist of a cylinder- or hollow cylinder-shaped metal body 36, which has a respective shell 37 with a lower, electrically insulating layer 38, a center layer 39 which conducts electricity well, and an outer layer 40, which is only limitedly electrically conductive.

At an end of the respective rollers 33, 34 a metallic contact ring 42 is arranged on a front end, whose interior diameter is in connection with the shaft journal 43, and whose periphery is in an electrically conducting connection with the electrically conducting center layer 39. This can be achieved, for example, in that the contact ring has a shell-like contact surface 44 on its periphery, which extends concentrically in respect to the metal body 36 and which in turn supports contact tips 46, which are arranged on its front face in a ring shape, are spaced apart from each other and are connected with the material of the center layer 39 which conducts electricity well.

The shaft journals 43—only one is represented—are seated in the bearing element 14 in bearings 47, which are also surrounded by an insulating material 48.

A wiper element 49, which is fixed on the bearing element 14 and is insulated against it, is connected with the contact surface 44 and is pressed by means of a spring force against the contact surface 44. As in the first exemplary embodiment, the wiper element 49 is respectively connected with a cable feed 26 and a cable 27.

In accordance with a third embodiment variation (FIG. 4), the rollers 51, 52 which act as charge electrodes, respectively consist of a stationary shaft journal 53, fixed on the frame in an insulating material 48 and having a roller body or metal body 36. The metal body 36 is provided with an electrically well conducting layer 39, for example a steel shell, above which an outer layer 40 of limited electrical conductivity is arranged. Respectively one bearing 47 is arranged on both sides between the shaft journal 53 and the steel shell.

The supply of electrical energy to the rollers 51, 52 takes place via a cable 27, which is in an electrically conducting contact with the shaft journal 53, for example the exterior 54 of the shaft journal 53.

It would of course also be possible to arrange the shell 39, 40 fixedly on the metal body 36 and to seat the journals 53, electrically insulated and rotatably in the bearing element 14 fixed in place in the lateral frame. In this case the cable 27 would have to be connected by means of a collector ring with the exterior 54 of the shaft journal 53.

In accordance with a fourth embodiment variation, not represented, the transfer of electrical energy to the ribbon 1 can also take place by means of conducting brushes, for example carbon brushes, arranged on both sides of the material webs of the ribbon 1.

It is furthermore possible to design the rollers 13, 16, 33, 34, 51, 52 also in the form of so-called sandwich rollers.

Such sandwich rollers consist, for example, of a rotatably seated shaft, which receives a number of disks, which are arranged, fixed against relative rotation, on the shaft in the radial direction. Here, a disk made of metal, for example steel, alternates with an adjoining disk, which consists of a metal body having an electrically well conducting layer 39, and above it an outer layer 40 of limited electrical conductivity (FIG. 3 or 4). Electrical energy is introduced via the shaft journal.

Such a sandwich roller can be placed against a ribbon 1 as an individual roller, or also in opposing pairs, for example as a pair of drawing rollers.

When used in pairs, both sandwich rollers should be arranged in such a way that respectively a metal disk of the first roller is placed opposite a layered disk of the second roller, and vice versa. Each roller of the pair of rollers has a different polarity.

List of Reference Numerals

| | |
|---|---|
| 1 | Ribbon |
| 2 | Cylinder folding group |
| 3 | Longitudinal folding device |
| 4 | Pair of funnel folding rollers |
| 5 | — |
| 6 | Pair of drawing rollers |
| 7 | Pair of drawing rollers |
| 8 | Cutter cylinder |
| 9 | Collection cylinder |
| 10 | — |
| 11 | Folding jaw cylinder |
| 12 | — |
| 13 | Roller, first (6, 7) |
| 14 | Bearing element (16) |
| 15 | — |
| 16 | Roller second (6, 7) |
| 17 | Metal body (16, 13) |
| 18 | Shell (16, 13) |
| 19 | Hub (16, 13) |
| 20 | — |
| 21 | Shaft journal (16, 13) |
| 22 | Roller bearing (14) |
| 23 | Bushing of insulating material |
| 24 | Bore, radial (23) |
| 25 | Intermediate ring |
| 26 | Cable feed |
| 27 | Cable (26) |
| 28 | Contact element |
| 29 | Annular flange |
| 30 | — |
| 31 | Piece of insulating material |
| 32 | Driveshaft |
| 33 | Roller (6, 7) |
| 34 | Roller (6, 7) |
| 35 | — |
| 36 | Metal body |
| 37 | Shell (33, 34) |
| 38 | Layer, lower (37) |
| 39 | Layer, center (37) |
| 40 | Layer, outer (37) |
| 41 | — |
| 42 | Contact ring (33, 34) |
| 43 | Shaft journal (33, 34) |
| 44 | Contact surface (42) |
| 45 | — |
| 46 | Contact tips (42) |
| 47 | Bearing (43) |
| 48 | Insulating material |
| 49 | Wiper element (33, 34) |
| 50 | — |
| 51 | Roller |
| 52 | Roller |
| 53 | Shaft journal |
| 54 | Exterior |

1. A device for electrostatically charging a multilayer ribbon (1) following the bringing together of the individual layers by means of oppositely polarized charge electrodes (13, 16, or respectively 33, 34, or respectively 51, 52), which are associated with the sides of the ribbon (1) located on the outside, characterized in that the charge electrodes (13, 16, or respectively 33, 34, or respectively 51, 52) are arranged so they touch the ribbon (1).

2. The device in accordance with claim 1, characterized in that the charge electrodes (13, 16, or respectively 33, 34, or respectively 51, 52) are embodied as rollers (13, 16, or respectively 33, 34, or respectively 51, 52) touching the ribbon (1).

3. The device in accordance with claim 2, characterized in that the two rollers (13, 16, or respectively 33, 34, or respectively 51, 52) are arranged directly opposite each other and press the ribbon (1) together.

4. The device in accordance with claim 1, characterized in that the charge electrodes (13, 16, or respectively 33, 34, or respectively 51, 52) are embodied as electrically conductive brushes touching the ribbon (1).

5. The device in accordance with claim 1, characterized in that the charge electrodes (13, 16, or respectively 33, 34, or respectively 51, 52) are arranged so they charge the ribbon (1) over its entire width.

6. The device in accordance with claim 2, characterized in that the roller bodies (17) of the rollers (13, 16) each are made of metal, are arranged electrically insulated in their bearing elements (14) and have a shell (18) of a coating which is limitedly electrically conductive.

7. The device in accordance with claim 2, characterized in that a feed line (27) for transmitting the electrical energy is respectively in contact with a journal (21, 43, 53) of the rollers (13, 16, or respectively 33, 34, or respectively 51, 52).

8. The device in accordance with claim 2, characterized in that the rollers (33, 34) respectively are made of a metal body (36) and have a shell (37), which has a lower, electrically insulating layer (38), a center layer (39) which conducts electricity well, and an outer layer (40), which is only limitedly electrically conductive.

9. The device in accordance with claim 8, characterized in that the feed line for the electrical energy is in contact via a wiper body (49), fixed in place on the bearing element with the center layer (30), which conducts electricity well, of the shell (37), that the shaft journals (43) are seated insulated against the bearing element (14).

10. The device in accordance with claim 2, characterized in that the rollers (13, 16, or respectively 33, 34, or respectively 51, 52) are respectively embodied as pairs (7) of drawing rollers.

11. The device in accordance with claim 10, characterized in that the pair (7) of drawing rollers is arranged directly in front of the entry into a cylinder folding group (2) of a folding apparatus.

12. The device in accordance with claim 2, characterized in that each roller (13, 16, or respectively 33, 34, or respectively 51, 52) is arranged to be separately driveable.

13. The device in accordance with claim 2, characterized in that the first roller (13, 33, 51) of the pair (7) of rollers is connected with a negative pole of a high tension d.c.-source, that the second roller (16, 34, 52) of the pair (7) of rollers is connected with a positive pole of a high tension d.c.-source, or vice versa.

14. The device in accordance with claim 2, characterized in that the journals (51, 52) each consist of a metal body (36), seated by means of journals (53) in the bearing element (14), and has an electrically well conducting layer (39) and an exterior, limitedly conductive layer (40) arranged thereon.

15. The device in accordance with claim 14, characterized in that the journals (53) are arranged insulated and fixed in place in the bearing element (14), that the layer (39, 40) is arranged rotatably on the metal body (36).

16. The device in accordance with claim 14, characterized in that the journals (53) are arranged insulated and fixed in place in the bearing element (14), that the layer (39, 40) is arranged fixed in place on the metal body (36).

17. The device in accordance with claim 14, characterized in that the supply of electrical energy takes place via the outside (54) of the journal (53).

18. The device in accordance with claim 2, characterized in that the rollers (13, 16, or respectively 33, 34, or respectively 51, 52) are embodied as so-called “sandwich rollers”.

19. A method for the electrostatic charging of a multilayered ribbon (1), characterized in that the ribbon (1) is charged by means of two rollers (13, 16, or respectively 33, 34, or respectively 51, 52), which press the ribbon (1) together and act as charge electrodes (13, 16, or respectively 33, 34, or respectively 51, 52).

20. A device for the electrostatic charging of a multilayered ribbon (1) by means of charge electrodes (13, 16, or respectively 33, 34, or respectively 51, 52), characterized in that the charging electrodes are embodied as two rollers (13, 16, or respectively 33, 34, or respectively 51, 52), which press the ribbon (1) together.

21. A device for the electrostatic charging of a material web (1) by means of oppositely polarized charge electrodes (13, 16, 33, 34) arranged on opposite sides of the material web (1), characterized in that the charge electrodes (13, 16, 33, 34) are embodied as electrically conductive brushes touching the material web (1).

22. A device for the electrostatic charging of a material web (1) by means of rollers (13, 16, 33, 34), which act as charge electrodes (13, 16, 33, 34) and touch the material web (1), characterized in that the roller bodies (17) of the rollers (13, 16) each are made of metal, are arranged electrically insulated in their bearing elements (14) and have a shell (18) of a coating which is limitedly electrically conductive.
